(19) United States
(12) Patent Application Publication
(10) Pub. No.: US 2017/0206497 A1
(43) Pub. Date: Jul. 20, 2017

(54) METHOD FOR DETERMINING THE REMAINING LIFE OF A THERMAL MASS IN A SHIPPING PACKAGE WHILE IN TRANSIT

(71) Applicant: KLATU NETWORKS, LLC, Poulsbo, WA (US)

(72) Inventor: Richard Kriss, Poulsbo, WA (US)

(73) Assignee: KLATU NETWORKS, LLC, Poulsbo, WA (US)

(21) Appl. No.: 15/473,581

(22) Filed: Mar. 29, 2017

Related U.S. Application Data
(63) Continuation-in-part of application No. 13/781,698, filed on Feb. 28, 2013.
Application No. 13/781,698 is a continuation-in-part of application No. 12/852,413, filed on Aug. 6, 2010.
Application No. 12/852,413 is a continuation of application No. 12/658,641, filed on Feb. 4, 2010, now abandoned.
(60) Provisional application No. 61/604,336, filed on Feb. 28, 2012.
(60) Provisional application No. 61/150,271, filed on Feb. 5, 2009.

(51) Int. Cl. G06Q 10/08; G01C 21/00; G01G 5/00

(52) U.S. Cl. CPC G06Q 10/0832; G01G 5/003; G01C 21/005

(57) ABSTRACT

A shipping container is described for use with methods for monitoring and controlling shipment of a temperature controlled material and determining the remaining useful life of a Thermal Source contained within the shipping container. The container comprises an inner enclosure adapted to carry one or more commodities during shipment, a bladder conformed to the inner surface of the inner chamber, or a plate upon which commodities are place, and instrumented with at least one transducer and at least one processing device configured to receive measurements from the at least one transducer. The processing device communicates the measurements to a networked device upon detecting the presence of a network. The networked device may transmit commands to the processing device that causes the processing device to adjust a configuration parameter.

### CLAIM OF PRIORITY UNDER 35 U.S.C. §119

The present application for patent is a continuation-in-part of U.S. patent application Ser. No. 12/852,413 filed Aug. 6, 2010, which is a continuation of U.S. patent application Ser. No. 12/658,641 filed Feb. 4, 2010, which claimed priority from U.S. Provisional Patent Application No. 61/150,271 filed Feb. 5, 2009, and the present application for patent is a continuation-in-part of U.S. patent application Ser. No. 13/781,698 filed Feb. 28, 2013, which claimed priority to Provisional Application No. 61/604,336 filed Feb. 28, 2012, and each of these applications is hereby expressly incorporated by reference herein.

### FIELD OF THE INVENTION

The present invention is in the field of methods for monitoring and controlling shipment of a temperature controlled material.

### BACKGROUND OF THE INVENTION

The transport of temperature-stabilized commodities such as research specimens and pharmaceuticals and other biologics (“commodities”) exposes the shipper to risk, uncertainty and high costs particularly when international shipping is involved. When a shipping package or container is in the hands of a shipping company, the shipper cannot easily determine the location and status of the shipment with respect to a planned delivery date, whether the commodities in the shipping package have been exposed to excessive temperatures, shock, vibration or tilt, and most importantly, whether cold-source commodities contained within the package such as dry-ice or liquid nitrogen (“Thermal Source”), have an adequate charge remaining to last for the expected (or unexpected) duration of the shipment.

In an attempt to mitigate these risks, shippers place remote telemetry devices within the package to log and sometimes transmit sensor data. Package monitoring devices are generally designed as offline data loggers where the data is harvested by connecting the data logger to a computer system through a universal serial bus (USB) connection after the shipment reaches its destination, when it is generally too late to intervene to replenish the Thermal Source during shipment for example.

Shippers of temperature stabilized products such as pharmaceuticals and research commodities see significant opportunity in new overseas markets. However, shipping commodities into those markets involves significantly greater risk and higher cost due to longer shipping times, prolonged exposure to shock and vibration and greater potential that the Thermal Source will be dissipated before the shipment is completed. To mitigate these risks, clinical trial research companies over allocate trial experiments to provide a margin of safety so that specimen degradation and drug losses attributable to the shipping process does not cause an insufficiency of clinical trial data. Today, the cost of developing a new drug averages $800 million. Although there is no set rule for the amount of over-allocation, five to 10 percent over-allocation is often mentioned. Taking the more conservative value of five percent, the cost of over allocation and the impact of specimen or drug losses due to risk factors in the cold-chain shipping process, it can be estimated that in a typical clinical trial, $40 million of trial costs could be avoided if risk factors in the shipping process were avoided or mitigated.

There is a need in the industry to mitigate these risks factors which can be achieved with more aggressive in-situ monitoring to identify, isolate and remediate problems in cold-chain shipping.

### SUMMARY OF THE INVENTION

Various aspects disclosed herein relate to the tracking and monitoring a package during shipping between two or more physically remote locations. In some aspects, the temperature of a payload of the package may be controlled during shipment. The temperature may be controlled within any desired range using a thermal mass that heats or cools an inner chamber or enclosure of the package. Certain examples are provided that illustrate the case of a cryogenic (very low temperature) package that may comprise a Dewar, a box, and/or other type of container. The thermal mass can be a hot or cold thermal mass. In certain aspects, the disclosure describes systems and methods that can be used with temperature controlled or temperature stabilized shipping containers used to transport commodities, including shipment of various commodities room temperature, refrigerated, frozen or deep-frozen cryogenic such as live cell bio-commodities, vaccines, tissues, etc., and various methods for monitoring and controlling shipments of commodities using an integrated packaging and monitoring system. A shipping container may include without limitation a box, a Dewar or any enclosure with a thermal source utilized for the transportation of temperature stabilized products or materials. In one example, a Dewar may be shipped within a box or other container. A method is provided for monitoring the status and sufficiency of the Thermal Source which is integrated with the design of the shipping container so as to provide resistance to shock and vibration as well as an additional source of thermal insulation.

According to an aspect of the description, a container that may be used in shipping comprises an inner space and/or enclosure (referred to interchangeably as “inner enclosure” or “inner space”) to carry a Thermal Source and one or more commodities during shipment, at least one transducer configured to determine weight of the inner space and/or enclosure, the Thermal Source and the one or more commodities, and a processor that may include a processor such as a processing device configured to receive measurements from the at least one transducer, and to communicate the measurements to a networked device upon detecting the presence of a network, wherein the measurements include a current weight of contents or an inner space and/or of the shipping package. The weight of the inner enclosure may include the weight of the one or more commodities, packaging and the Thermal Source. Knowing the weight of the shipping package, the inner container, the Thermal Source and the commodities contain within, the current weight of the Thermal Source may be determined as the difference between the initial weight of the inner enclosure and a current weight of the inner enclosure. Using formulae derived from prior analysis of the rate of depletion of the Thermal Source including consideration of the effects external forces known to affect the rate of depletion of the Thermal Source such as cumulative time-in-transit, periods of rest, movement, shock, vibration, tilt, temperature and humidity, a shipper can determine a priori if the projected remaining life of the Thermal Source will be sufficient to maintain desired temperatures until the shipping container reaches its final destination.

According to an aspect of the description, the processing device, a network or cloud-hosted application processes the measurements. The networked or cloud-hosted device may transmit a command to the processing device that causes the processing device to adjust a configuration parameter. The configuration parameter may configure one or more of a sensor sample interval, a preferred network communication route, an allowed or prohibited network communication route, and a remote control of an annunciator provided on the shipping container.

According to an aspect of the description, the processing device may be configured to determine a location of the shipping container based on the presence or absence of network infrastructure. The network infrastructure may comprise one or more processing devices associated with other shipping containers. The processing device may be configured to determine a location of the shipping container based on absence or presence of shipping scan-codes received from the carrier that are associated with the shipping container or from other parameters such as outside temperature, a sound frequency, altitude, absence or presence of a network, and time-in-transit. The processing device may be configured to determine a location of the shipping container based on coordinates derived from a GPS signal. The shipping container may be determined to be located within a structure when no GPS signal is detected.

According to an aspect of the description, information transmitted by the processing device is fused with data received from a customer or carrier, wherein the data includes one or more of custody transfer, time, state and weight information and networks detected along a shipping route.

According to an aspect of the description, at least one bladder may be conformed to the inner surface of the inner chamber and instrumented with the at least one transducer. The at least one bladder may comprise a plurality of segments, each segment maintaining a uniform pressure such that vectors of arrival of the shock and vibration is perpendicular to the one or more commodities. Each of the at least one transducer may measure the pressure of at least one segment of the bladder.

According to an aspect of the description, the at least one bladder conformed to the inner surface of the inner chamber may have a shape adapted to provide protection of the Thermal Source and the one or more commodities or other materials.

According to an aspect of the description, a band may be configured to maintain the at least one bladder in a desired position. The at least one transducer may include a strain gauge configured to measure the stress load of the band in response to the pressure of the bladder or bladder segment, the stress load being indicative of the weight of the Thermal Source. The stress load may measure differential pressure between at least a segment of a bladder and external atmospheric pressure. The differential pressure may be indicative of the weight of the Thermal Source. One or more of a change detected in radio frequency environment, an absence or presence of a network, the differential pressure, a vibration, an acceleration and a tilt may be used to determine if the shipping container is on an aircraft or other vehicle. Pressure measurements may be based on an evaluation of tilt or orientation of the shipping container in relation to the center of the earth. The bladder may comprise a material or mesh having elastic properties that limit volumetric expansion, thereby assuring accurate pressure measurement. The measurement of the stress load of the band may be used to determine the weight of the one or more commodities. The at least one bladder may absorb shock and vibration and provide thermal insulation.

According to an aspect of the description, the at least one transducer may be coupled to a plate located under the inner enclosure. The at least one transducer may comprise a microelectromechanical system (MEMS) device or a similar device capable of measuring stress or load.

### BRIEF DESCRIPTION OF THE DRAWINGS

FIG. 1 is an exploded view showing a cryogenic shipping package that includes a Dewar enclosed within in a shock absorbing material.

FIG. 2 is a block diagram illustrating a shipping container adapted according to certain aspects of the invention.

FIG. 3 illustrates a smart module according to certain aspects of the invention.

FIG. 4 illustrates network access by a smart module according to certain aspects of the invention.

FIG. 5 illustrates a shipping container adapted according to certain aspects of the invention.

FIG. 6 illustrates a shipping container that has been adapted according to certain aspects of the invention.

FIG. 7 is a flowchart illustrating a method of using a shipping container adapted according to certain aspects of the invention.

FIG. 8 is a simplified block schematic illustrating a processing system employed in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the descriptions herein are intended to encompass other embodiments including a plurality of the same component, and vice-versa, unless explicitly stated otherwise. Moreover, applicants do not intend for any term in the specification or claims to be ascribed an uncommon or special meaning unless explicitly set forth as such. Further, embodiments of the present invention encompass present and future known equivalents to the components referred to herein by way of illustration.

Certain embodiments of the invention enable gathering of data from a shipping container during shipment. The data may include information related to external forces such as shock, vibration and tilt observed at the shipping container or to the contents contained therein, and environmental conditions surrounding the container such as temperature and pressure experienced by the container during shipment. The data may include location information associated with the container, including one or more locations of the container during shipment that may be determined using one or more of RFID detection, MAC-address association, GPS or RF presence sensing, carrier scan-codes, RF triangulation or trilateralization. The data may be used to determine if the remaining life of a Thermal Source associated with the container is sufficient to provide protection until the planned delivery of the container at its destination, with sufficient margin to cover unexpected delays. If it is determined a priori that the remaining life of the Thermal Source is insufficient, the data may be used to trigger an intervention measure to cause the shipment to be intercepted in order to replenish the Thermal Source, before delivery of the shipping container to the final destination or to direct it an alternate destination where the replenishment of the Thermal Mass can be accomplished with less delay.

### Tracking an Object in Transit

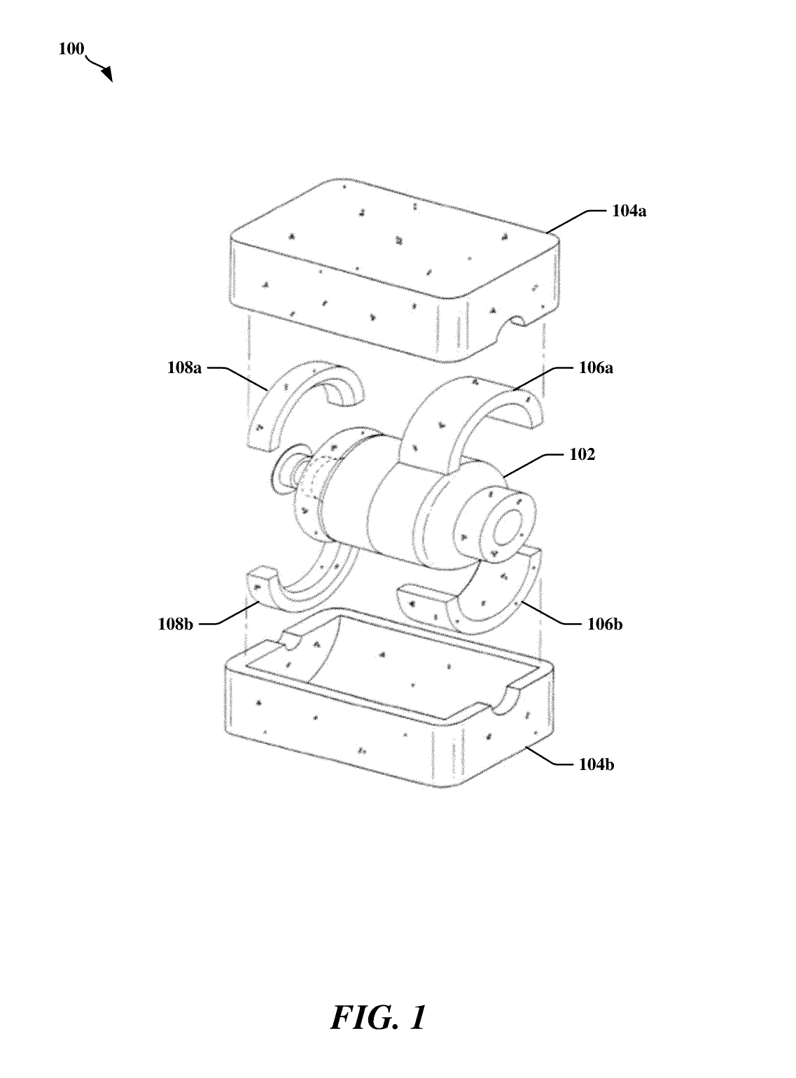

FIG. 1 is an exploded view showing one example of a shipping package 100. In the example, the shipping package 100 includes a Dewar 102 enclosed within a container or shell 104a, 104b 104a, 104b. The Dewar 102 may be omitted or replaced by a box or other container. The Dewar 102 may be surrounded or partially surrounded by shock absorbing components 106a, 106b, 108a, 108b. The Dewar 102 may be configured as a dual-walled cryogenic container that carries a material or payload to be shipped and a thermal source. In one example, the thermal source includes liquid nitrogen that provides a necessary or desired refrigeration capacity. In another example, the thermal source includes produces heat at a desired rate. The shipping package 100 may include electronics devices, including a smart module used for tracking purposes and transducers or sensors attached or inserted within the shipping package 100. In one example, the sensors may include one or more thermocouple wires that operate as temperature probes. In another example, a wireless location sensor may be attached or inserted within the shipping package 100. In various example, electronics devices are configured or adapted to monitor various parameters associated with the environment, condition or status of the health of the contents and/or location of the shipping package 100. In some instances, the wireless location sensor may be located within a plug inserted into the neck tube of the Dewar 102. In some applications, it may be necessary or desirable to power-down or turn off the wireless location sensor when the shipping container is onboard an airplane, for example, when regulations prohibit certain devices from being used during portions of flights such as takeoff and landing.

A data logger provided in the shipping package 100 to monitor and periodically record temperature in the shipping package 100 during transit. The data logger may record other parameters associated with the shipping package 100. The data logger may be accessed physically and/or wirelessly and a data log copied, removed or transferred during shipment of the shipping container and/or once the shipping container is returned to a reprocessing facility. Such information can prove valuable in dealing with issues relating to liability that might arise if a specimen is damaged during shipment, or in settling questions relating to whether any such damage to the contents did in fact occur during shipment and the circumstances of the damage (e.g., location and time damage occurred). A data logger can be included in a smart module. In order to monitor the temperature or any other parameter of the sample chamber of the shipping container the sample chamber itself can be monitored with sensors to measure the status or condition of the chamber contents, for example, the temperature in the sample chamber can be monitored by use of a proxy calculation based upon a temperature reading taken outside of the sample chamber. For example, if the temperature reading is taken in the neck tube, a simple calculation can be used to calculate what the actual temperature in the sample chamber will be based upon the distance between the sample chamber and the location of the temperature sensor in the neck tube.

In some instances, a temperature monitor may be implemented using a wireless transmitter coupled to one or more sensors such as temperature sensors for example, which may be combined with the wireless location sensor and/or a smart module as disclosed herein. When the environmental and location sensors are integrated into a single unit with data recording, location data can be included with temperature and other sensor data in the data log. A temperature sensor may be used to trigger an alert if a rise in temperature is detected or if the temperature in the sample chamber exceeds a preselected threshold temperature or lies outside a preselected temperature range. Providing periodic location and/or temperature within the shipping package 100 may be indicative of the health of the shipping package 100 according to at least one preselected criterion such as, for example, anticipated remaining time required for the shipping package 100 to reach a customer destination. An alert can also be generated upon detection of a trend predicting that the temperature in the sample chamber will exceed a preselected threshold temperature within a predetermined time.

According to certain aspects disclosed herein, a smart device provided in the shipping package 100 may monitor location, temperature and state of health of the contents and sufficiency of the remaining energy contained within thermal mass via wireless tracking using a web portal. In one example, the weight of the shipping package 100 and its thermal mass such as dry-ice or LN2 cryogen can be recorded and then subsequent measurements of weight can be used to calculate how much cryogen has been discharged and then, based upon the cryogen remaining, calculate the expected life of the remaining cryogen charge. Knowing the rate of discharge of the cryogen can also be used to compare anticipated discharge against actual discharge and then use the actual rate of discharge to recalculate remaining life of charge.

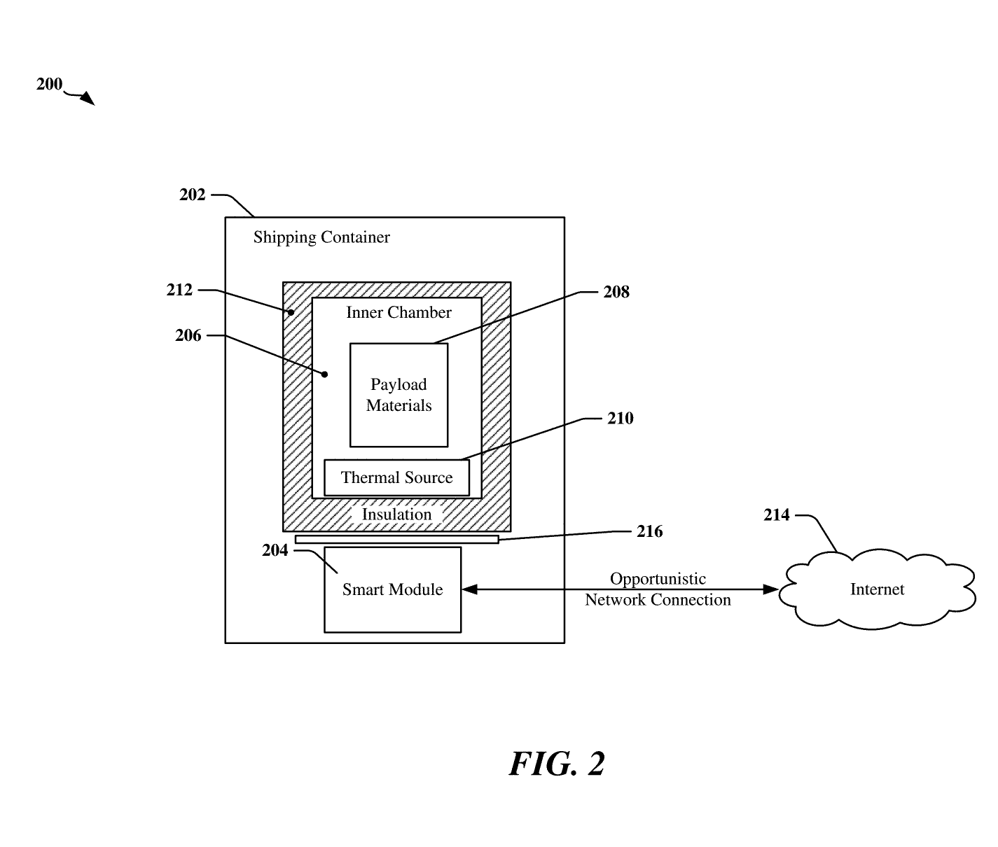

FIG. 2 is a block diagram 200 illustrating certain aspects of a smart container, which may be referred to herein as a “Shipping Container 202.” The Shipping Container 202 may comprise an instrumented container, a package, box or other enclosure that can be utilized for the transport of commodities. The Shipping Container 202 may be constructed from multiple enclosures that contribute to maintaining the integrity of a commodity transported within the Shipping Container 202. For example, the Shipping Container 202 may comprise an impact-resistant container or shell 104a, 104b that encloses a Dewar 102 (see FIG. 1) or some other temperature-stabilizing storage element. The Shipping Container 202 may be configured to carry payload materials 208 under temperature stabilized conditions. The Shipping Container 202 may comprise more than one package, box or other type of container.

In the block diagram 200 of FIG. 2, certain features of the Shipping Container 202 are illustrated as an enclosure having an inner enclosure 206 provided within a layer of insulation 212. Certain principles described herein apply equally to a Shipping Container 202 that employs a multi-chambered package, including a package that encloses another package that carries payload materials 208. For example, the inner enclosure 206 may be provided by a Dewar 102 or other container carried within a container or shell 104a, 104b. The inner enclosure 206 and/or inner space may provide an insulated or non-insulated containment volume configured to maintain commodities under temperature stabilized conditions. In at least some embodiments, the Shipping Container 202 includes a thermal source 210 which may comprise a or phase-change material such as dry-ice, hot or cold gel-packs or liquid nitrogen and temperature stabilizing commodities.

In certain embodiments, a Smart Module 204 and/or one or more transducers or sensors may be attached to, or inserted within the Shipping Container 202 (which combination may be referred to herein as a smart container). Smart Module 204 may be configured to communicate opportunistically with a fixed network with an access point such as the Internet 214 or to another network that may be accessed through a mobile access point, which may be attached to or carried by a person, animal or vehicle for example. The contents of the Shipping Container 202, comprising the thermal source 210, commodities and/or specimens 208, and the Smart Module 204 may be co-located within the Shipping Container 202 such that the contents rest upon a plate 216 or bladder (not shown) allowing the weight of the contents to be measured by means of a transducer coupled to the plate 216, or from a measurement of pressure within the bladder.

In certain embodiments, the Shipping Container 202 is adapted or adaptable to carry commodities such as pharmaceuticals, vaccines, tissue samples, cell-lines, specimens, sera, synthetic or radioactive commodities, etc. Commodities transported by the Shipping Container 202 may be referred to herein as Commodities.

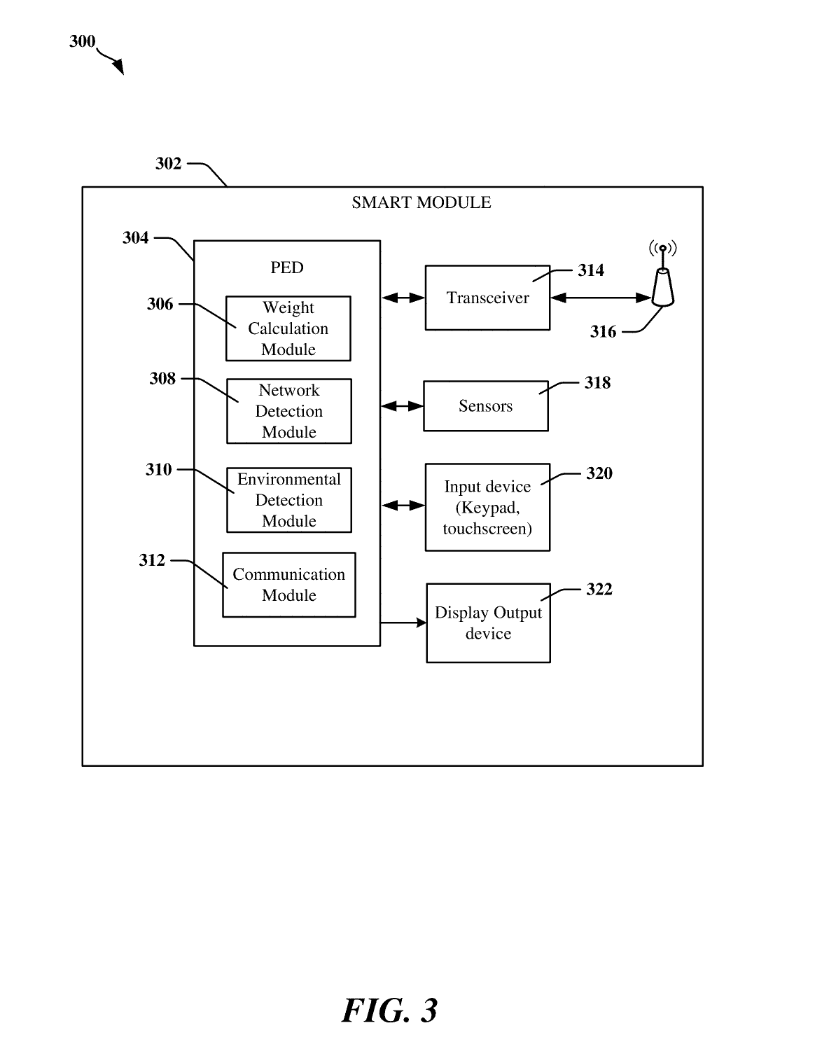

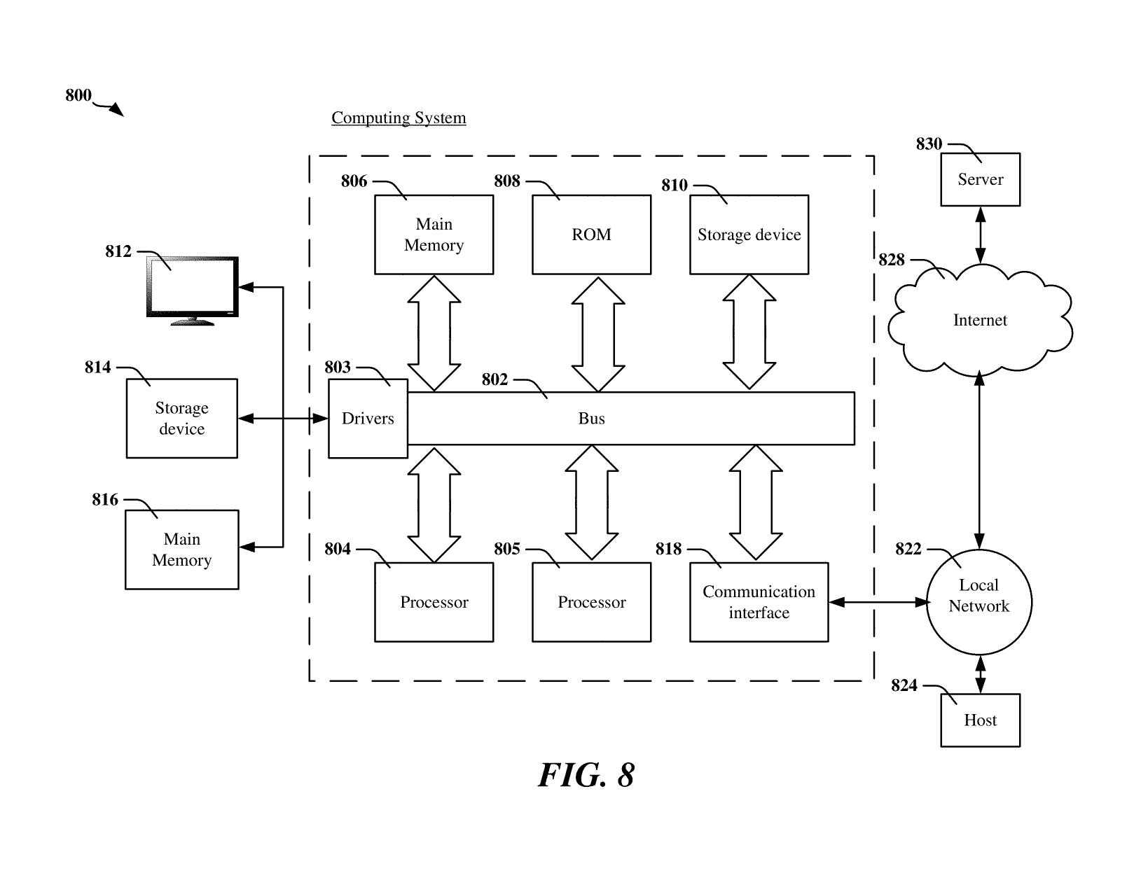

With reference also to the block diagram 300 of FIG. 3, Smart Module 302 may be configured to connect to a network 316 by any available means. For the purposes of this description, a Smart Module 302 may comprise a processing circuit such as programmable electronic device (PED) 304. PED 304 may have some of or all of the elements shown in FIG. 8 and described in more detail below. PED 304 may include one or more of a power source, a display, a CPU, nonvolatile storage, a light emitting diode (LED) lamp or indicator, a button or switch, an aural alarm indicator, a radio frequency or optical or infrared transmitter and/or receiver, a global positioning system receiver, and analog-to-digital (A/D) converter, and a digital-to-analog converter (D/A). PED 304 may include or be coupled to a sensor or multiple sensors 318. The sensors 318 may comprise transducers that can be used to sense or measure pressure, acceleration, temperature, humidity, magnetic field, light, load, inclination, radio frequency identification (RFID) signals and or RFID return signals, whether related to a passive or active RFID tag. PED may additionally comprise a battery or energy scavenging device and a wired, wireless, infrared, or magnetically coupled interface 314 that is coupled to an antenna 316 used for communications.

A Smart Module 302 may be added to the Shipping Container 202 to obtain a Smart Shipping package, which comprises a, cooled insulated package that monitors and reports status of a thermal source 210, package condition and location and that monitors, records and tracks significant events associated with a Smart Shipping package. Smart Module 302 may employ sensors 318 and one or more RF transceivers 314 that enable tracking the Shipping Container 202 while in transit. One or more RF transceivers 314 may respond to interrogation by networks encountered at various points while in transit. The one or more RF transceivers 314 may communicate and/or be associated with a plurality of distinct networks, rather than associating with a single logical network through a single login credential. In one example, the RF transceivers may transmit and receive data over any available network, including a plurality of different networks using different credentials.

The RF transceivers 314 may interrogate or otherwise initiate communication through networks encountered at various points while in transit. The Smart Module 302 may be interrogated by one or more devices connected to a network 214 upon establishment of connection between the Smart Module 302 and the network 214. The Smart Module 302 may also proactively transmit information through the network 214 upon determining presence of a suitable access point or access network and negotiating a connection with the access point or access network. The Smart Module 302 may transmit information using standard and proprietary network protocols in a connection-based or connectionless mode of operation. The Smart Module 302 may use telecommunication networks to send, for example, short messages and/or units of data.

The Smart Module 302 may refrain from communicating based on its location or mode of transit. In one example, the Smart Module 302 may suspend communication activities when it determines that the Shipping Container 202 is located aboard an airplane, during take-off and landing, for example. The determination to refrain or recommence communication may be made based on an analysis of elapsed time, location, in response to monitored sensor inputs (temp, altitude, vibration, vibration, RF frequency detection, noise identifiable as speech, jet engines, machinery etc., absence of GPS signals when indoors, exposure to magnetic fields, orientation, presence or absence of (i) light or lighting with detectable characteristics (i.e. Kelvin), or absence thereof, and (ii) by external commands provided via magnetic, infrared or RF communications, and/or the detection of certain RF frequencies or determination of the presence or absence of a certain wireless transmitters, or a network address.

The Smart Module 302 may determine location of the Shipping Container 202 may be determined at various points during transit. A monitoring system may determine or infer the location of an object by correlating identifiable information in a wireless emission or transmission such as RF, infrared, magnetic, electromagnetic and other media, which is associated with a known and previously determined location. This may be accomplished by means of a single received transmission and/or by a series of related and/or unrelated emissions and/or transmissions. The Smart Module 302 may further determine or infer the location of an object by correlating scan code information provided by handlers of the Shipping Container 202 or by third parties. Scan code information typically comprises actual location information or location identifications made by inference or deduction from scan code information and/or the fusion of scan code information with other sensor or network information.

The Smart Module 302 may determine or infer the location of the Shipping Container 202 using GPS, by RFID “readers” or purposefully placed beaconing transmitters at pre-positioned “choke points” and/or by cellular network triangulation. The Smart Module 302 may determine or infer the location of an object within a building or finite area by means of an analysis of Received Signal Strength Indications (RSSI) or Time Differential of Arrival (TDOA) from one or more transceivers.

The Smart Module 302 may determine or infer the location of the Shipping Container 202 using an estimate of where the object should be based on the time elapsed since the Shipping Container 202 departed its point of origin. The Smart Module 302 may determine or infer the location of the Shipping Container 202 by observing the number of “hops” and duration of each hop, in a shipment as defined by a barometer detecting ascension to altitude.

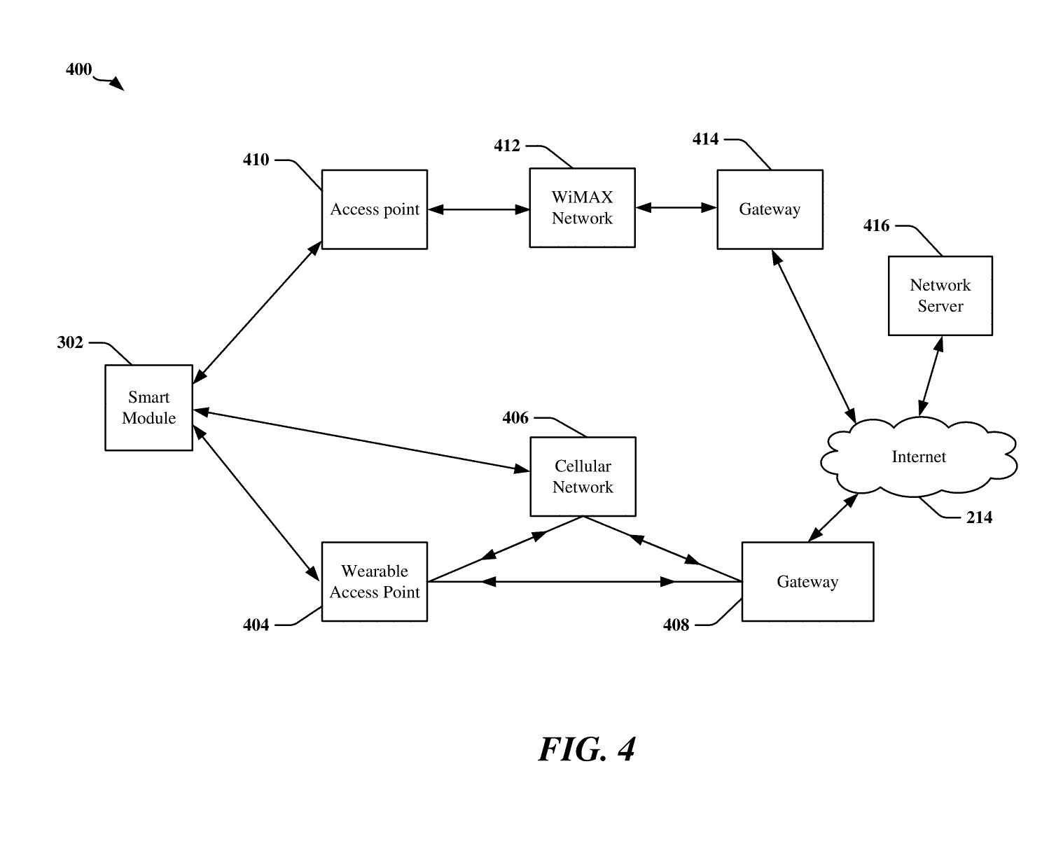

With reference also to the network diagram 400 of FIG. 4, The Smart Module 302 may exchange data with networked entities 416 using one or more networks 214. The Smart Module 302 may be configured to transmit data utilizing a single end-to-end routable protocol containing a self-originated source and destination address. The Smart Module 302 may send requests or receive responses to associate with, authenticate and join a network, thence send and receive data to and from the destination address which may include and instructions for additional actions and communications based on a delivery receipt or reply, all while executing in a single network session. Such network may be fixed in location such as in a warehouse or sort facility, or encountered along a route while in transit. The process of information gathering or data harvesting from one or more Smart Modules 302 may be referred to herein as “data backhaul.” Data may be harvested by means of a Personal Area (PAN) network, a continuous wireless local-area network (WLAN) or a wide-area (WAN) connection such as GPRS, LTE or other cellular network 406, and/or a low-power wide-area network 412 such as LoRA or Sigfox, and/or through purpose-built data collection agents placed in third party (e.g. customer or partner) locations and at strategic “choke-points” along the route of a shipping lane.

Data may be harvested using access points 410, peer devices 404 and other opportunistic network connections. Opportunistic harvesting may occur (i) when the object senses the availability of a temporary or transient wireless local area network (WLAN) or personal area network (PAN) agents 404 at any time during their journey, (ii) when two or more objects exchange information among each other (ad-hoc) such that the first object that reaches a network connection uploads information from all other objects it encountered in its journey, and (iii) through mobile data collection agents which come in proximity to an object. Mobile data collection agents may be purposefully mounted on a vehicle or worn by a person or animal. In one example, the location of a Shipping Container 202 may be known and its logs offloaded through body-worn access points and/or worker cell phones enabled for opportunistic

### Monitoring Weight of Commodities in an Object in Transit

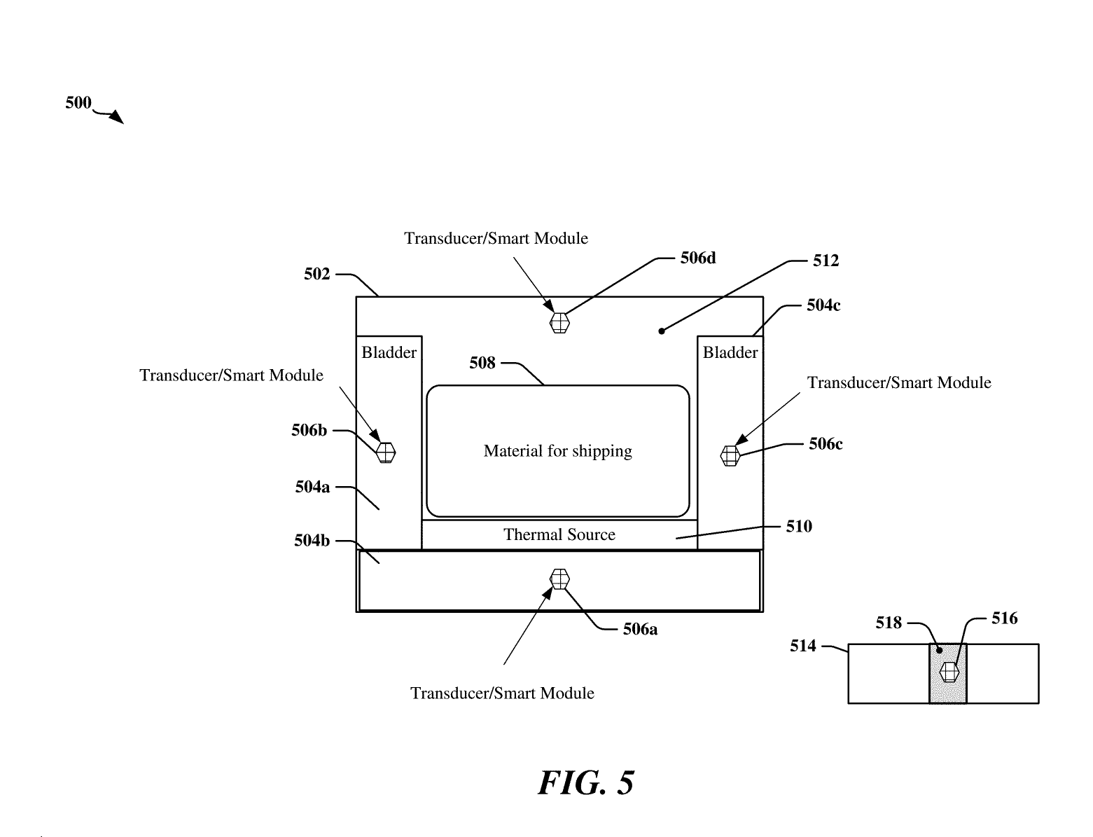

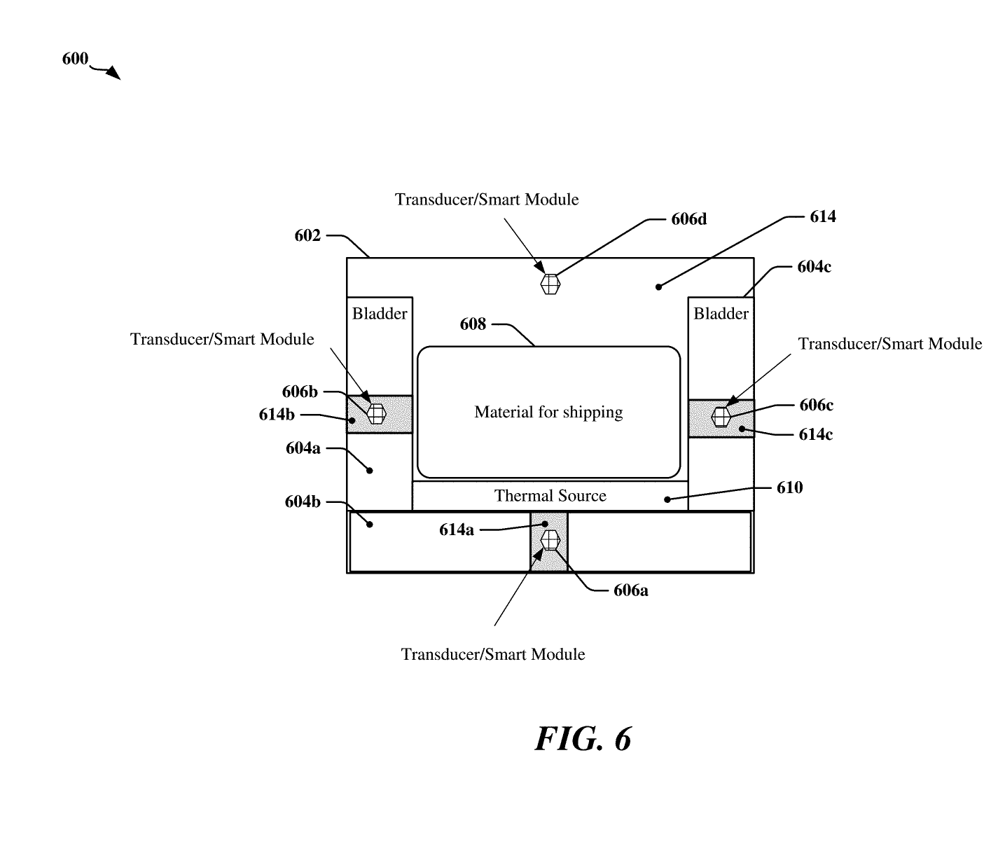

FIGS. 5 and 6 illustrate example configurations 500 and 600 of a Smart Container 502 or 602 that provide apparatus and methods for monitoring and/or measuring weights of payloads 508, 608 and/or Thermal Sources 510, 610 carried in the Smart Container 502 or 602.

In a first configuration 500, a commodity may be carried as a payload 508 within an inner enclosure 512, which may be insulated. The payload 508 may be mounted on, and/or adjacent to one or more bladder segments 504a, 504b, 504c which can provide thermally insulation as well as impact resistance. The bladder segments 504a, 504b, 504c may be part of a single bladder component and/or may be distinctly different bladders, which may be independently inflated for example. In certain embodiments, the Shipping Container 502 may comprise one or more transducers or Smart Modules 506a, 506b, 506c that can be used to measure the weight and/or status of a Thermal Source 510 used to maintain thermal stability of the payload 508 and/or the inner enclosure 512. In one example, the Thermal Source 510 may be configured to maintain the payload 508 within a desired temperature range. The bladder segments 504a, 504b, 504c may comprise a pressurized package, vessel or balloon-like device of size, shape and configuration adapted to the physical structure of the Smart Container 502 and/or the payload 508. One or more of the bladder segments 504a, 504b, 504c may be instrumented using sensors coupled to a Smart Module 506a, 506b, 506c, 506d, which may be provided internally, partially internally, or entirely externally to the bladder segments 504a, 504b, 504c. In one example, a primary Smart Module 506d may communicate with other Smart Modules 506a, 506b, 506c that incorporate and/or are coupled to sensors. In one example, pressure detected in the bladder segments 504a, 504b, 504c may indicate a current combined weight of the payload 508 and the Thermal Source 510, where the difference from initial measured weight may be used to determine the expected remaining life of the Thermal Source 510. The pressure measured in the bladders may be adjusted by known measurements of the pressure altitude surrounding the bladder. The measured current combined weight of the payload 508 and the Thermal Source 510 can be compensated to Account for orientation and tilt of the container 502, as well as ambient temperature and external air pressure. More than one bladder segment 504a, 504b, 504c may be provided to accommodate different orientations and tilts.

The sensors monitored by the Smart Modules 506a, 506b, 506c, 506d may include electromechanical and/or electromagnetic transducers configured to determine the current weight of the package. Load cells may be located in the bottom of a container, for example, where at least one wall or plate is located under the Thermal Source 510 and can be measured by a transducer coupled to one or more of the at least one wall or plate. In another example, the container 502 may be fitted with one or more load cells constructed using a MEMS device deployed between two rigid walls or plates that may be fabricated from a polymer, metal or suitable material. Load cells and/or other transducers may be provided around the container 502 to permit the weight of the payload 508 and/or the Thermal Source 510 to be measured regardless of orientation of the devices and/or tilt of the package. Commodities to be shipped in the payload 508 and a Thermal Source 510 may be placed in the container 502. Given the weight of the container when empty and the weight of the commodities, the weight of the phase-change material 510 can be calculated by simple arithmetic. Adjustments may be made based on orientation and/or tilt.

Certain embodiments comprise a Thermal Source 510 which may include a phase change material, a catalytic material, a mechanical device, and electro-mechanical system or other material or device which provides or removes thermal energy from the Shipping Container 502 or an inner enclosure of the Shipping Container 502 to heat or cool the Commodities or commodities carried as the payload 508 in the Shipping Container 502. In one example, the phase-change material may include dry ice.

In some embodiments, one or more bands 518 may be placed around a bladder segment 514. The one or more bands 518 may be configured to maintain the bladder and/or a corresponding bladder segment 514 in a desired position. Each of the one or more bands 518 may be fitted with a strain gauge 516 to measure the strain or stress load in the one or more bands 518. The strain gauge may be coupled to a smart module, for example. The measurement of the stress load of the one or more bands 518 can be used to determine the weight of commodities in the payload 508 and the Thermal Source 510. The weight of the Thermal Source 510 can be expected to vary with changes in the weight of the Thermal Source 510.

In a second configuration 600, a commodity may be carried as a payload 608 within an inner enclosure 612, which may be insulated. The payload 608 may be mounted on, and/or adjacent to one or more bladders 504a, 504b, 504c, 604a, 604b, 604c which can provide thermally insulation as well as impact resistance. In certain embodiments, the Shipping Container 602 may comprise one or more transducers and/or Smart Modules 606a, 606b, 606c that can be used to measure the weight and/or status of a Thermal Source 610 used to maintain thermal stability of the payload 608 and/or the inner enclosure 612. In one example, the Thermal Source 610 may be configured to maintain the payload 608 within a desired range. Each Smart Module 606a, 606b, 606c may be mounted on a band 614a, 614b, 614c that is provided around at least a portion of a corresponding bladder 604a, 604b, 604c. The one or more bands 614a, 614b, 614c may be configures to maintain corresponding bladders 504a, 504b, 504c, 604a, 604b, 604c in position, for example. The bladders 504a, 504b, 504c, 604a, 604b, 604c may comprise a pressurized package, vessel or balloon-like device of size, shape and configuration adapted to the physical structure of the Smart Container 602 and/or the payload 608. One or more of the bladders 504a, 504b, 504c, 604a, 604b, 604c may be instrumented using additional sensors coupled to a Smart Module 606a, 606b, 606c, 606d, which may be provided internally, partially internally, or entirely externally to the bladders 504a, 504b, 504c, 604a, 604b, 604c. In one example, a primary Smart Module 606d may communicate with other Smart Modules 606a, 606b, 606c that incorporate and/or are coupled to sensors. In one example, pressure detected in the bladders 504a, 504b, 504c, 604a, 604b, 604c may indicate a current combined weight of the payload 608 and the Thermal Source 610, where the difference from initial measured weight may be used to determine the expected remaining life of the Thermal Source 610. The pressure measured in the bladders may be adjusted by known measurements of the pressure altitude surrounding the bladder. The measured current combined weight of the payload 608 and the Thermal Source 610 can be compensated to Account for orientation and tilt of the container 602, as well as ambient temperature and external air pressure. More than one bladder 604a, 604b, 604c may be provided to accommodate different orientations and tilts.

The sensors monitored by the Smart Modules 606a, 606b, 606c, 606d may include electromechanical and/or electromagnetic transducers configured to determine the current weight of the package. Load cells may be located in the bands 614a, 614b, 614c. Load cells may be located at the bottom of a container when, for example, stress or strain in at least one wall or plate located under the Thermal Source 610 can be measured by a transducer coupled to one or more of the at least one wall or plate. In another example, the container 602 may be fitted with one or more load cells constructed using a MEMS device deployed between two rigid walls or plates that may be fabricated from a polymer, metal or suitable material. Load cells and/or other transducers may be provided around the container 602 to permit the weight of the payload 608 and/or the Thermal Source 610 to be measured regardless of orientation of the devices and/or tilt of the package. Commodities to be shipped in the payload 608 and a Thermal Source 610 may be placed in the container 602. Given the weight of the container when empty and the weight of the commodities, the weight of the phase-change material 610 can be calculated by simple arithmetic. Adjustments may be made based on orientation and/or tilt.

Certain embodiments comprise a Thermal Source 610 which may include a phase change material, a catalytic material, a mechanical device, and electro-mechanical system or other material or device which provides or removes thermal energy from the Shipping Container 602 or an inner enclosure of the Shipping Container 602 to heat or cool the Commodities or commodities carried as the payload 608 in the Shipping Container 602. In one example, the phase-change material may include dry ice.

In some of these embodiments, devices attached to one or more bands 614a, 614b, 614c may include sensors configured to measures the pressure of at least one corresponding bladder 604a, 604b, 604c or bladder segment. One or more of the devices may include a processor. Some of these embodiments comprise one or more bands 614a, 614b, 614c configured to maintain corresponding bladders 504a, 504b, 504c, 604a, 604b, 604c in a desired position. In some of these embodiments, a strain gauge may be provided on certain bands 614a, 614b, 614c, where a strain gauge may be configured to measure the stress load of the corresponding band, the stress load being indicative of the weight of the Thermal Source 610. In some of these embodiments, the measurement of the stress load of the band 614a, 614b, 614c is used to determine the weight of the one or more commodities. In some of these embodiments, the one or more bladders 504a, 504b, 504c, 604a, 604b, 604c absorb shock and vibration. In some of these embodiments, a bladder 604a, 604b, 604c may be multi-segmented, each segment maintaining a uniform pressure such that vectors of arrival of the shock and vibration are perpendicular to the one or more commodities.

Certain embodiments of the invention can stabilize temperature by maintaining a specific range of temperature in the Shipping Container or an inner enclosure of the Shipping Container using a Thermal Source and a means of insulating the contents from the forces of the environment. In one example, the Shipping Container may be at least partially wrapped in a thermally non-conductive material. In another example, the Shipping Container may comprise one or more layers that are thermally non-conductive. In another example, the Shipping Container may comprise an interstitial space that encloses a gas, a low-pressure gas and/or a vacuum. Temperature stabilization may be employed to store Commodities at, above, or below a targeted temperature range at, above, or below freezing. When used for maintaining a predefined ambient or near-ambient temperature, the shipping container may rely on thermal mass to accomplish temperature stability. In certain embodiments, the Shipping Container may be shipped through the services of a carriage, transportation or overnight shipping company or by a third-party logistics provider.

Every year approximately 60 million parcels are shipped through domestic and international carriers to end-points around the world, each containing sensitive and valuable commodities. Almost all carriers offer extra-cost services to track, monitor and manage these shipments which frequently require special handling to protect their contents and require special documentation or export/import licenses.

Many government entities and agencies, such as the United States Food and Drug Administration (FDA), provide indirect control and supervision over the manufacture, shipping, storage and distribution of regulated products by requiring each manufacturer to develop and maintain FDA approved standard operating procedures (SOPs). SOPs prescribe the steps, sequences, methods and actions that will be employed by the manufacturer and their business partners to assure the proper handling, storage and distribution of regulated products. The SOP development process necessarily requires “proof” through documented testing proving that the prescribed methods and procedures contained within the SOP will result in the delivery of Commodities that are safe and effective and not otherwise damaged or degraded due to improper manufacture, handling or storage and distribution.

The FDA considers conformance to SOPs a matter of important public policy contributing to the health and safety of our health care system. Accordingly, there are many regulations published by FDA and other government or quasi-government agencies to enforce standards and “best-practices” on the shipment of temperature stabilized commodities. Manufacturers of regulated products whose manufacturing, shipping, storing or distribution activities fail to conform to FDA approved SOPs are subject to fines, or in extreme cases, revocation of previously granted approvals.

Although the research activities including the shipment of commodities used in research are exempt from government regulation, many non-regulated companies comply or partially comply with industry best practices relating to temperature stabilized commodities in order to reduce risk and uncertainty in research and product development process. Taken all together, the market for the shipment of temperature stabilized commodities is large, and exposes companies involved in the process to high cost and risk. Certain aspects of the invention reduce the risk of inaccurate test results, fines and the high cost of specialized packaging and services, and provide systems and methods for transporting commodities at less cost and with more predictability and reliability.

For the purposes of this discussion, it will be assumed that shipping companies such as Federal Express, DHL, United Parcel Service (UPS), World Courier, offer specialty extra-cost services to assist manufacturers and distributors with conformance with SOPs. Aspects of the current invention supplement or replace shippers shipping and logistics processes, and address the unique requirements of cold-chain shipping.

The transport of temperature stabilized commodities involves risk, uncertainty and high cost. The risk and uncertainty are attributable to the inability of shippers to monitor the condition and status of the shipment and the health of the commodities contained therein, once it is placed in the hands of a shipping company. High costs are incurred when the commodities in a temperature stabilized shipping container are damaged or lost due to environmental conditions such as shock or loss inability to maintain a desired temperature.

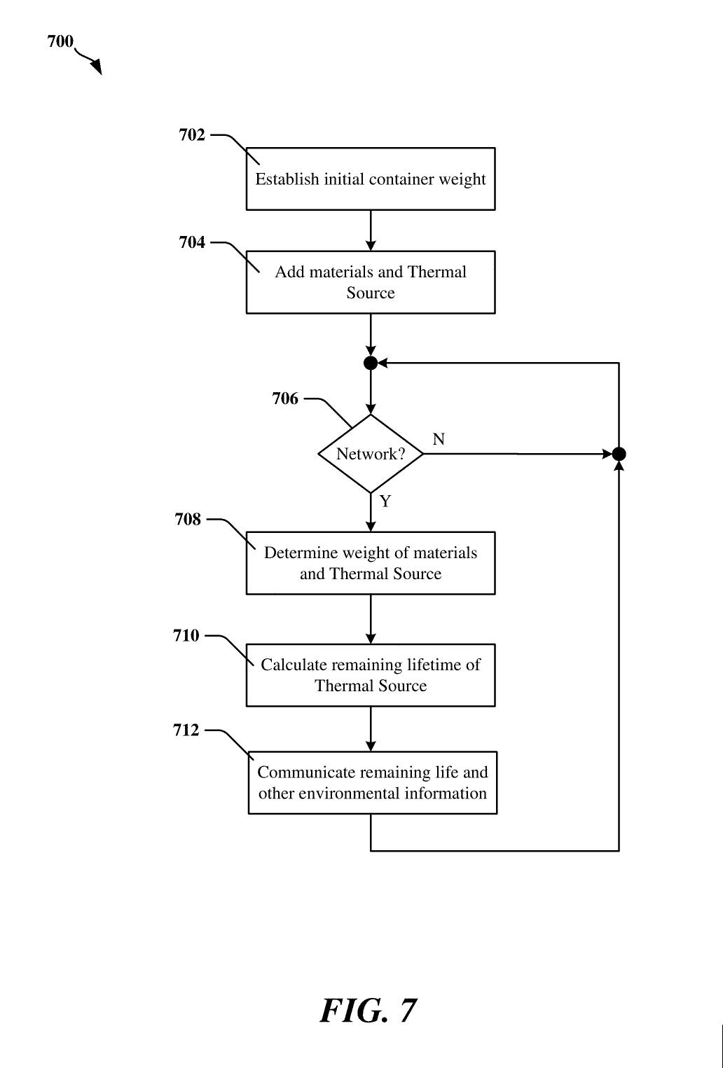

FIG. 7 is a flowchart 700 that illustrates a process performed by PED 304 of Smart Module 302. At step 702, circuit or module 306 may determine the initial weight of the container 202 using one or more sensors 318. At step 704, the container 202 may be loaded with material 208 and thermal source 210.

At step 706, the Smart Module 302 may determine the presence of one or more networks using circuit or module 308, transceiver 314 and antenna 316. At step 708, the Smart Module 302 may determine, in response to, or advance of, the detection of a network, the current weight of the commodities 508, 608 and Thermal Source 510, 610. At step 710, the Smart Module 302 may calculate the remaining lifetime of the Thermal Source 310. At step 712, the Smart Module 302 may communicate environmental information including the remaining life of the Thermal Source 510, 610 to a network entity 214.

Aspects of the present invention enable the provisioning of smart shipping containers, which may comprise a specialized packaging coupled with electronics that combine an optimized packaging solution with features of tracking, sensing, communications, insulation and shock absorption properties into a single integrated packaging and shipping solution. Aspects of the present invention provide the means for a shipper to monitor the health, condition and remaining useful life of the Thermal Source 510, 610 and commodities while in the custody of a carrier.

Certain embodiments of the invention comprise a Shipping Container that has one or more pressure-filled bladders 504a, 504b, 504c, 604a, 604b, 604c or vessels configured to have a specific shape, size and volumetric capacity to conform to the shape of the Shipping Container or an inner enclosure of the Shipping Container. The bladders 504a, 504b, 504c, 604a, 604b, 604c are typically provided on the bottom, top or sides of the Shipping Container. Commodities and a Thermal Source 510, 610 may be placed on top of a single bladder segment and/or within the envelope of the bladders 504a, 504b, 504c, 604a, 604b, 604c for shipment.

Each of the bladders 504a, 504b, 504c, 604a, 604b, 604c may have shock absorption and insulation properties sufficient to protect the Commodities carried within the Shipping Container. Bladders 504a, 504b, 504c, 604a, 604b, 604c may be instrumented using a wireless programmable electronic device adapted to determine the weight of the Thermal Source 510, 610 through translation of pressure forces exerted on upon the bladder 504a, 504b, 504c, 604a, 604b, 604c by the Thermal Source 510, 610 and/or the Commodities carried within the Shipping Container. In one example, a change in the measured weight of the Shipping Container, Commodities and thermal mass may be attributable to decreased mass of the Thermal Source 510, 610. Through repeated measurements and simple arithmetic calculation, the mass of any remaining Thermal Source 510, 610 can be calculated and tracked over a period of time. The mass of the remaining Thermal Source 510, 610 can be used to determine one or more of the effectiveness of the Thermal Source 510, 610, the condition of the Commodities and the probability that the remaining Thermal Source 510, 610 material will be sufficient to maintain a desired level of temperature stabilization at or until the time of delivery or expected time of delivery, and/or for a time period after delivery or after expected time of delivery due to unanticipated delays detected during the shipping process.

In some embodiments, determination of effectiveness of Thermal Source 510, 610 can be made based on remaining mass of the Thermal Source 510, 610, rate of decline of thermal mass and/or environmental conditions such as shock, vibration and tilt experienced by the Shipping Container. Knowledge of the state of the Thermal Source 510, 610 may prevent damage or loss of the Commodities shipped in the Shipping Container. For example, if a shipper knows a priori that the remaining mass (of dry ice or liquid nitrogen, for example), or energy of a Thermal Source 510, 610 was insufficient to provide temperature stabilization until the date of planned or expected delivery of the container plus a reasonable margin, the shipper may be able to arrange to have the Shipping Container intercepted during shipment in order to take corrective action.

In one embodiment of the invention, a bladders 504a, 504b, 504c, 604a, 604b, 604c is placed in the bottom of the Shipping Container. The known weight of the Commodities added to the Shipping Container may be recorded and/or measured along with the weight of the Thermal Source 510, 610 such as dry ice or liquid nitrogen placed within the shipping container. While enroute, the weight of the Thermal Source 510, 610 can be determined by sensors coupled to the bladders 504a, 504b, 504c, 604a, 604b, 604c and reported via a wireless network. The information captured by the sensors may be used to calculate remaining mass and useful life of the Thermal Source 510, 610. Calculations may be made by a Smart Module attached to the Shipping Container and/or by a computing system that receives measurements and other information from the Shipping Container, typically through a network such as the Internet.

Certain aspects of the invention can assist enterprises, corporation, individuals and other entities to reduce shipping costs by providing data about the environmental conditions that the Shipping Container has been exposed to during shipment. In addition, the bladders 504a, 504b, 504c, 604a, 604b, 604c may provide increased shock absorption and insulation. The bladders 504a, 504b, 504c, 604a, 604b, 604c may enable shippers to programmatically determine the amount of thermal energy remaining in a temperature stabilized Shipping Container using ad-hoc or deterministic remote communications.

Certain aspects of the invention may reduce risk and shipping costs by providing systems and methods for gathering data from a Shipping Container during shipment. The data includes information about the forces (shock, vibration and tilt) and environmental factors (temperature and pressure) that the Shipping Container has been exposed to during shipment. The data can be used to determine if the remaining life of the Thermal Source is sufficient to provide protection until the expected date/time of delivery plus a margin.

Certain aspects of the invention may reduce risk and shipping costs by providing a low-cost re-usable shock absorption and insulative solution that is green and not hazardous. Certain aspects of the invention may reduce risk and shipping costs by providing a means to determine the location of the shipment using RFID, MAC-address association, GPS or RF presence sensing, carrier scan codes, RF triangulation or trilateralization.

Certain embodiments of the invention provide a smart shipping container. Some embodiments comprise a smart module and instrumented bladders 504a, 504b, 504c, 604a, 604b, 604c, and may be configured to carry one or more commodities.

In some embodiments, an electronic device is attached or otherwise coupled to the bladders 504a, 504b, 504c, 604a, 604b, 604c. The electronic device may comprise a smart module configured to communicate monitored parameters to a network and through the network to a server or one or more cloud-resident applications. In some embodiments, the monitored parameters and other information may be processed and analyzed by the applications. In some embodiments, a cloud or server application can send a command back to the package to adjust configuration parameters or to determine if its location has changed. Configuration parameters may comprise sensor sample intervals, preferred, allowed or prohibited routes for network communications, and remote control of annunciators or visual media such as LED, or LCDs on the Smart Module or Shipping Container.

In some embodiments, the smart module may determine its location by reference to detected network infrastructure in the area. In some embodiments, the smart module may determine its location by detection or communication with other Smart Modules RF or RFID transmitters that may be present or absent nearby. In some embodiments, the smart module may determine its location by the absence or presence of Carrier generated shipping scan-codes received and processed by application servers. In some embodiments, the smart module may determine its location by through GPS derived coordinates, or through inference of other factors such as outside temperature, sound frequencies, vibration or inclination patterns, presence or absence of carrier scan codes, altitude or time-in-transit.

In some embodiments, the smart module may form a mesh network with other smart modules to extend communications range, improve throughput or share, compare or exchange data among themselves or with applications servers. In some embodiments, the smart module may issue a local auditable or visual alarm when any measurement or any condition observed is deemed critical or threatening to the protection of the commodities.

In some embodiments, data received from a smart module may be fused with data received from carriers such as custody transfer, time, state and weight information. New information may be inferred from the merged data to improve the accuracy of location or delivery information, the health and status of the shipping container itself or the predictions and confidence of such predictions into the future.

In some embodiments, one or bladders 504a, 504b, 504c, 604a, 604b, 604c have an intelligent shape to conform to the contours of the smart shipping container or an inner enclosure or container that contains or carries commodities. In some embodiments, the intelligent shape of the bladders 504a, 504b, 504c, 604a, 604b, 604c maximizes protection of the Thermal Source and commodities from external forces known to affect or cause an accelerated loss of energy by the Thermal Source. In some embodiments, the design and shape of the bladders 504a, 504b, 504c, 604a, 604b, 604c minimizes the movement of the inner enclosure or container and/or the commodities.

In some embodiments, the design and shape of the bladders 504a, 504b, 504c, 604a, 604b, 604c can accommodate protrusions from a Dewar such as handles or fill tubes and may contain other design features such as pockets to hold commodities, accessories and documentation. The bladders 504a, 504b, 504c, 604a, 604b, 604c may be provided with one or more smart modules, each measuring the pressure of one bladder segment. In some embodiments, one smart module may measure the pressure of all bladder segments.

In some embodiments, the one or more bladders 504a, 504b, 504c, 604a, 604b, 604c may comprise one or more windows, placed within the one or more bladders 504a, 504b, 504c, 604a, 604b, 604c to permit visual inspection of objects surrounded by the one or more bladders 504a, 504b, 504c, 604a, 604b, 604c. In some embodiments, the bladders 504a, 504b, 504c, 604a, 604b, 604c and smart shipping container may have a clamshell design comprising an upper section and a lower section to facilitate assembly or as a means of improving the accuracy of the bladder segmentation strategy which results in improved accuracy of physical measurements.

In some embodiments, bands 518, 614a, 614b, or 614c placed around the bladder 504a, 504b, 504c, 604a, 604b or 604c may maintain the bladder 504a, 504b, 504c, 604a, 604b or 604c in a desired position. The band 518, 614a, 614b, or 614c may also contain a strain gauge to measure the strain or stress load of the band 518, 614a, 614b, or 614c, which varies depending on the weight of the Thermal Source 510. The measurement of the stress load of the band 518, 614a, 614b, or 614c is used to determine the weight of commodities but more importantly the Thermal Source 510.

In some embodiments, at least one bladder 504a, 504b, 504c, 604a, 604b, 604c absorbs shock and vibration and protects the commodities. Bladders 504a, 504b, 504c, 604a, 604b, 604c can be multi-segmented, each segment maintaining a uniform pressure such that the vector arrival of shock or vibration is perpendicular to the stored commodities and shipping container. In some embodiments, differential pressure, the pressure inside the bladder or bladder segment and the atmospheric pressure outside the bladders 504a, 504b, 504c, 604a, 604b, 604c, is used to adjust pressure measurements due to changes in atmospheric pressure. In some embodiments, differential pressure may also be used to calculate altitude by fusing sensor information such as acceleration and barometric to determine if the smart shipping container is located in an airplane, for example.

In some embodiments, the smart module can determine which bladder 504a, 504b, 504c, 604a, 604b, 604c or bladder segment is capable of providing the most accurate pressure measurement based on the evaluation of its tilt or orientation in reference to the center of the earth. In some embodiments, the bladders 504a, 504b, 504c, 604a, 604b, 604c comprise a material or mesh having elastic properties that limit volumetric expansion thereby assuring an accurate pressure measurement for any varying amount of weight placed upon it.

In some embodiments, remaining thermal energy or energy potential of the Thermal Source is determined by periodically determining the current weight of the Thermal Source during the shipping process. In some embodiments, the current weight is determined by taking a pressure measurement at a point in time when the weight of the Thermal Source is perpendicularly aligned with one or more bladders 504a, 504b, 504c, 604a, 604b, 604c or bladder segments. The alignment may be determined by evaluating information from other sensors or the pressure in other segments of the bladder 504a, 504b, 504c, 604a, 604b, 604c or by evaluating the tilt, or orientation of the package position relative to the center of the earth. In some embodiments, algorithms may be employed to calculate weight if the smart shipping container is not perfectly aligned with the center of the earth.

In some embodiments, the bottom surface of a bladder 504a, 504b, 504c, 604a, 604b, 604c is designed to provide optimal surface contact with and orientation to the bottom of the smart shipping container in order to achieve a reliable pressure measurement for any given amount of tilt or inclination. Another embodiment of this concept might apply to the sides and top of the smart shipping container so that an accurate weight measurement can be achieved for any given amount of tilt or inclination.

In various examples of the second configuration 600, an apparatus adapted according to certain aspects disclosed herein includes a container 602 having an inner chamber 614 adapted to carry a thermal source 610 and a payload 608 during shipment. The inner chamber 614 may be defined by and inner surface or wall of the container 602. The container 602 may be shipped between two remote locations. The apparatus may include a bladder 604a, 604b, 604c conformed to at least a portion of the inner surface of the container 602, and a band 614a, 614b, 614c may be provided around the bladder. The apparatus may be equipped with a plurality of sensors 606a, 606b, 606c, 606d, which may include a strain gauge attached to the band 614a, 614b, 614c and configured to measure stress load in the band 614a, 614b, 614c. The stress load in the band 614a, 614b, 614c may indicate the combined weight of the thermal source 610 and the payload 608. The plurality of sensors 606a, 606b, 606c, 606d may be included in a smart module. The apparatus may include a processing device coupled to the strain gauge and configured to determine an initial weight measurement of the thermal source 610 based on a measurement of stress load provided by the strain gauge and prior measurements of weight of the thermal source 610 and the payload 608, adjust the initial weight measurement to correct for tilt or inclination of the apparatus, establish an opportunistic connection with a network at a plurality of locations along a shipping route, and communicate measurements of weight or stress load to a networked device when the opportunistic connection is established at one of the plurality of locations along the shipping route.

The apparatus may include one or more additional bladders 604a, 604b, 604c conformed to a portion of the inner surface of the container 602, and corresponding additional bands 614a, 614b, 614c provided around the additional bladders 604a, 604b, 604c. The plurality of sensors may include strain gauges attached to the additional bands 614a, 614b, 614c and configured to measure stress load in the additional bands 614a, 614b, 614c. The processing device is coupled to the additional strain gauges and configured to adjust the initial weight measurement based on measurement of stress load provided by the additional strain gauges. Tilt or inclination of the apparatus may be determined calculated from measurements of stress load in a plurality of bands 614a, 614b, 614c provided around a plurality of bladders 604a, 604b, 604c.

In some examples, the bladder comprises a plurality of bladder segments, where bands are provided around each corresponding bladder segment. The plurality of sensors may include strain gauges attached the bands, with each strain gauge being configured to measure stress load in a corresponding band. The processing device may be configured to adjust the initial weight measurement based on measurements of stress load provided by a plurality of strain gauges. The apparatus of claim 4, wherein tilt or inclination of the apparatus is determined calculated from measurements of stress load in the plurality of bands provided around the plurality of bladder segments. The plurality of bladder segments is configured to maintain a uniform pressure such that vectors of arrival of shock and vibration are perpendicular to the commodity. The plurality of sensors may include at least one transducer configured to measure a pressure of at least one bladder segment.

In some examples, the networked device processes the measurements using a cloud-resident application. The networked device may transmit a command to the processing device that causes the processing device to adjust a configuration parameter. The configuration parameter may configure one or more of a sensor sample interval, a preferred network communication route, an allowed network communication route, a prohibited network communication route, or a remote control of an annunciator provided on the apparatus. An annunciator may be a visual indicator or audible alarm.

In some instances, the measurements are communicated to the networked device through an end-to-end network, utilizing a single protocol, in a single stateful session where the processing device self-determines the source and final destination address of the data.

In various examples the processing device is configured to determine a location of the apparatus based on:
the presence or absence of network infrastructure detected by the processing device or absence of network infrastructure detectable by the processing device,
the presence or absence of a processing device associated with one or more other apparatus,
coordinates derived from a GPS signal, where the apparatus is determined to be located within a structure when no GPS signal is detected, and
one or more factors including an outside temperature, a sound frequency, altitude, absence of a network, presence of a network, a network address, or time-in-transit.

In one example, one or more of a change detected in radio frequency environment, absence of a network, presence of a network, a differential pressure, a vibration, an acceleration or a tilt is used to determine if the apparatus is on an aircraft or other vehicle.

Information transmitted by the processing device may be fused with data received from a customer or carrier, wherein the data includes one or more of custody transfer, time, state information, weight information or networks detected along a shipping route.

In some embodiments, the plurality of sensors includes a transducer configured to provide differential pressure between at least a segment of at least one bladder and external atmospheric pressure, wherein the differential pressure is indicative of the weight of the thermal source.

In some embodiments, bladders may be constructed from a material or mesh having elastic properties that limit volumetric expansion and assure accurate pressure measurement. At least one of the plurality of sensors is configured to measure stress load associated with the material or mesh. The bladder may be configured to absorb shock and vibration affecting the shipping container during shipment.

In some embodiments, the band is configured to maintain the bladder in a desired position.

In some embodiments, at least one transducer coupled to a plate located under the thermal source. The latter transducer or transducers may comprise a MEMS device.

### System Description

Turning now to FIG. 8, certain embodiments of the invention employ a processing system that includes at least one computing system 800 deployed to perform certain of the steps described above. Computing systems may be a commercially available system that executes commercially available operating systems such as Microsoft Windows®, UNIX or a variant thereof, Linux, a real-time operating system and or a proprietary operating system. The architecture of the computing system may be adapted, configured and/or designed for integration in the processing system, for embedding in a shipping container. In one example, computing system 800 comprises a bus 802 and/or other mechanisms for communicating between processors, whether those processors are integral to the computing system 800 (e.g. 804, 805) or located in different, perhaps physically separated computing systems 800. Device drivers 803 may provide output signals used to control internal and external components

Computing system 800 also typically comprises memory 806 that may include one or more of random access memory (“RAM”), static memory, cache, flash memory and any other suitable type of storage device that can be coupled to bus 802. Memory 806 can be used for storing instructions and data that can cause one or more of processors 804 and 805 to perform a desired process. Main memory 806 may be used for storing transient and/or temporary data such as variables and intermediate information generated and/or used during execution of the instructions by processor 804 or 805. Computing system 800 also typically comprises non-volatile storage such as read only memory (“ROM”) 808, flash memory, memory cards or the like; non-volatile storage may be connected to the bus 802, but may equally be connected using a high-speed universal serial bus (USB), Firewire or other such bus that is coupled to bus 802. Non-volatile storage can be used for storing configuration, and other information, including instructions executed by processors 804 and/or 805. Non-volatile storage may also include mass storage device 810, such as a magnetic disk, optical disk, flash disk that may be directly or indirectly coupled to bus 802 and used for storing instructions to be executed by processors 804 and/or 805, as well as other information.

Computing system 800 may provide an output for a display system 812, such as an LCD flat panel display, including touch panel displays, electroluminescent display, plasma display, cathode ray tube or other display device that can be configured and adapted to receive and display information to a user of computing system 800. Typically, device drivers 803 can include a display driver, graphics adapter and/or other modules that maintain a digital representation of a display and convert the digital representation to a signal for driving a display system 812. Display system 812 may also include logic and software to generate a display from a signal provided by system 800. In that regard, display 812 may be provided as a remote terminal or in a session on a different computing system 800. An input device 814 is generally provided locally or through a remote system and typically provides for alphanumeric input as well as cursor control 816 input, such as a mouse, a trackball, etc. It will be appreciated that input and output can be provided to a wireless device such as a PDA, a tablet computer or other system suitable equipped to display the images and provide user input.

According to one embodiment of the invention, processor 804 executes one or more sequences of instructions. For example, such instructions may be stored in main memory 806, having been received from a computer-readable medium such as storage device 810. Execution of the sequences of instructions contained in main memory 806 causes processor 804 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 804 and/or 805, particularly where the instructions are to be executed by processor 804 and/or 805 and/or other peripheral of the processing system. Such medium can include non-volatile storage, volatile storage and transmission media. Non-volatile storage may be embodied on media such as optical or magnetic disks, including DVD, CD-ROM and Blu-ray. Storage may be provided locally and in physical proximity to processors 804 and 805 or remotely, typically by use of network connection. Non-volatile storage may be removable from computing system 804, as in the example of Blu-ray, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, Blu-ray, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 800. Such media can include twisted pair wiring, coaxial cables, copper wire and fiber optics. Transmission media can also include wireless media such as radio, acoustic and light waves. In particular, radio frequency (RF), fiber optic and infrared (IR) data communications may be used.

Various forms of computer readable media may participate in providing instructions and data for execution by processor 804 and/or 805. For example, the instructions may initially be retrieved from a magnetic disk of a remote computer and transmitted over a network or modem to computing system 800. The instructions may optionally be stored in a different storage or a different part of storage prior to or during execution.

Computing system 800 may include a communication interface 818 that provides two-way data communication over a network 820 that can include a local network 822, a wide area network or some combination of the two. For example, an integrated services digital network (ISDN) may be used in combination with a local area network (LAN). In another example, a LAN may include a wireless link. Network link 820 typically provides data communication through one or more networks to other data devices. For example, network link 820 may provide a connection through local network 822 to a host computer 824 or to a wide area network such as the Internet 828. Local network 822 and Internet 828 may both use electrical, electromagnetic or optical signals that carry digital data streams.

Computing system 800 can use one or more networks to send messages and data, including program code and other information. In the Internet example, a server 830 might transmit a requested code for an application program through Internet 828 and may receive in response a downloaded application that provides for the anatomical delineation described in the examples above. The received code may be executed by processor 804 and/or 805.

Certain embodiments of the invention provide host systems as well as deployable electronic tags that include a computing system 80, albeit having different capacities and capabilities. One system may generate a shipping order using a process performed by a computing system 800 in which a processor executes one or more sequences of instructions. For example, such instructions may be stored in main memory 806, having been received from a computer-readable medium such as a storage device 814. Execution of the sequences of instructions contained in the main memory 806 causes one or more processors 804 and/or 805 to perform process steps according to certain aspects of the invention. In certain embodiments, functionality may be provided by embedded computing systems that perform specific functions wherein the embedded systems employ a customized combination of hardware and software to perform a set of predefined tasks. In one example, an alert may be generated upon detection of a trend predicting that the temperature in a sample chamber will exceed a preselected threshold temperature or temperature range within a predetermined time. In this example, once periodic location and temperature data are received based upon input from, for example, an opportunistic network connection, the data is saved in memory 806 or 816 and then used to determine the periodic health of the sample chamber according to at least one preselected criteria. Criteria can include at least one variable obtained when the customer order is initiated. If an alert is generated, another combination of hardware and software might be used to notify a monitoring agent (which may or may not be a person) or to generate corrective action. Thus, embodiments of the invention are not limited to any specific combination of hardware circuitry and software.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for tracking objects in motion and/or transit. In some of these embodiments, the object comprises a shipping container. In some of these embodiments, the object comprises a vehicle that transports products and materials. Typically, the object encounters networks at various points while in transit. The object may be interrogated by devices connected to the network upon establishment of connection between the object and the network through a bi-directional process. In some embodiments, the object may also proactively transmit information through the network upon determining presence of a suitable network and negotiating a connection with the network. The object may transmit information using standard and proprietary network protocols in a connection-based or connectionless mode of operation. The object may use known fixed or one or more opportunistically discovered telecommunication networks while in transiting along a route. The object may send, for example, short messages and/or units of data utilizing a single end-to-end routable protocol containing a source and destination network address. The object may send and receive data to and from the destination address which may include instructions for additional actions to be performed by the source or destination device, all while executing by means of a single network session. The object may be adapted to transmit measurements and other parameters and/or status to a cloud-resident application through an end-to-end network. The transmission of such measurements, parameters and/or status may be effected utilizing a single protocol, in a single stateful session where the processing device self-determines the source and final destination address of the data. The object may include a processing device that enables a processing device associated with the object to adjust a configuration parameter or install a firmware update. In one example, a shipping container may include a processing device configured to determine a location of the object and/or a shipping container based on the presence or absence of a unique network address or opportunistic wireless network infrastructure detected by the processing device.

In some of these embodiments, the object comprises an environmentally controlled container. For example, a temperature-controlled chamber may be provided within the container. Temperature may be controlled by any combination of electrothermal, electrochemical and/or electromechanical means. In some embodiments, liquid nitrogen may be used to maintain a desired temperature of the chamber.

Certain embodiments comprise systems and methods for monitoring remaining cooling capacity of the container. Remaining cooling capacity can be calculated based on battery charge, available liquid nitrogen, ambient temperature and other factors. In some of these embodiments, remaining life can also include an assessment of one or more of the following: the amount of time a container, flask and/or Dewar 102 is in a tilted orientation, the amount of shock and acceleration to which the object and/or container is exposed, ambient temperatures, the weight of the object, volume of the chamber, contents of the chamber and estimates of these factors. In some of these embodiments, a visual indication of the condition and remaining life may be displayed on the object.

Certain embodiments of the invention provide systems and methods for operating an environmentally controlled chamber. The object may include a processing device and/or a machine-readable storage device that enables a processor to maintain and receive pre-programmed instructions determining power control associated with the object. In some of these embodiments, on/off times may be specified that anticipate future availability of opportunistic network connections. In some of these embodiments, requirements may be specified that determine when to record a sensor parameter. The instructions may be generated based on a comparison of observed data compared to an analysis of historical information gathered by other monitoring devices traversing a similar route to the object in transit. The route may lie between cities, states and countries. The route may equally lie between points in a building.

In some of these embodiments, a control device provided in the object can decide when the device must not transmit, e.g. when aboard an airplane. In some of these embodiments, on/off determination is accomplished by means of an analysis of elapsed time, location (see location), in response to monitored sensor inputs (temp, altitude, vibration, vibration, RF frequency detection (speech, jet engines, machinery etc.), exposure to magnetic fields, orientation, presence or absence of (i) light or lighting with detectable characteristics (i.e. Kelvin), or absence thereof, and (ii) by external commands provided via magnetic, infrared or RF communications, or the detection of certain RF frequencies or determination of certain network address.

In some of these embodiments, location of the object may be determined at various points during transit. A monitoring system may determine or infer the location of an object by correlating identifiable information in a wireless emission or transmission (RF, infrared, magnetic etc.), which has a known and previously determined location. This may be accomplished by means of a single received transmission and/or by a series of related and/or unrelated emissions and/or transmissions. A monitoring system may further determine or infer the location of an object by correlating scan code information provided by handlers of the object or by third parties. Scan code information typically comprises actual location information or location identifications made by inference or deduction from scan code information and/or the fusion of scan code information with other sensor or network information.

In some of these embodiments, a monitoring system may determine or infer the location of an object using a global positioning system (GPS), by RFID “readers” at pre-positioned “choke points” and/or by cellular network triangulation. In some of these embodiments, a monitoring system may determine or infer the location of an object within a building or finite area by means of an analysis of Received Signal Strength Indications (RSSI) or Time Differential of Arrival (TDOA) from one or more transceivers.

In some of these embodiments, a monitoring system may determine or infer the location of an object using an estimate of where the object should be based on the time elapsed since the object departed its point of origin. In some of these embodiments, a monitoring system may determine or infer the location of an object by observing the number of “hops” and duration of each hop, in a shipment as defined by a barometer detecting ascension to altitude.

In some of these embodiments, data can be collected from a plurality of objects in transit using one or more networks. The process of information gathering or data harvesting from these objects will be referred to here as “data backhaul.” Data may be harvested by means of a continuous wireless network (WLAN) connection such as GPRS or WiMAX, for example and/or through purpose-built data collection agents placed in third party (e.g. customer or partner) locations and at strategic “choke-points” along the route of a shipping lane.

In some of these embodiments, data may be harvested by means of opportunistic network connections. Opportunistic harvesting may occur (i) when the object senses the availability of a temporary or transient LAN or PAN agents at any time during their journey, (ii) when two or more objects exchange information among each other (ad-hoc) such that the first object that reaches a network connection uploads information from all other objects it encountered in its journey, and (iii) through mobile data collection agents which come in proximity to an object. Mobile data collection agents may be purposefully mounted on a vehicle, mobile object or worn by a person or animal. In the reverse, once it is determined that the data has been delivered through the ad-hoc network to its intended destination, a method is employed to terminate the collection and propagation of data using promiscuous network connections, which is accomplished using a similar viral method in the reverse direction to cause cached data shared among the agents to be purged or rendered inert.

Certain embodiments of the invention provide a portal for monitoring, tracking and controlling objects in transit. The portal may be deployed in a network “cloud” such that available computing resources can be quickly scaled for performance or deployed in a geographically diverse manner for reliability. The portal may be designed for load-balancing and fault-recovery such that a failing server is removed from service and the remaining “twin” assumes 100% of the processing load until service can be restored. Certain portals may provide real-time monitoring of system internals, and services to detect any stoppage of the system and alarm notification upon such detection. In some of these embodiments, a wizard is provided to assist with data entry: in-grid editing may be provided to simplify data entry and validation of information on a per-field instead of a per-form basis.

In some of these embodiments, automatic generation of customs and regulatory documentation that will accompany the shipment can be provided, thereby eliminating the need for the customer to prepare such documentation in connection with complex shipments. Some of these embodiments comprise programmatic creation of a “Shipping Plan” which contains all of the necessary steps and shipping procedures to complete the order, essentially constructing a work-flow model or required steps to completion. Some of these embodiments comprise methods for Analyzing scan codes to determine if a shipment is progressing according to the dates and milestones expected by the shipping plan. Some of these embodiments comprise “learning” features which can operate by means of analysis of scan codes over time so as to “profile” a shipping lane and comparing actual versus expected shipping activities and details.

Some of these embodiments provide a system that can programmatically re-issue repeat orders in response to data entry selections. Moreover, the system may be capable of programmatically generating an invoice to the customer or business partner, for all services covering all legs contained within a single order.

Some of these embodiments provide exception handling and management. Exception analysis is a continuous process of statistically calculating or analyzing observed sensor readings, locations and scan codes over time so as to construct a learned “profile” of the shipping lane that represents the typical, mean, average, best or worst conditions observed of the lane as measured by time, sensor readings, network information and location. The system can programmatically infer that a shipping anomaly has occurred based on comparing observed data with historical profiles, and internal “rules” are applied to the observed versus expected information to determine if an exception has occurred and if human intervention is required.

In some embodiments, exceptions can be inferred when any data received from the device or vendor system is believed to be un-correlated with respect to expected values as determined by prior analysis and inferences derived from similar shipments, over identical or similar routes, with like objects and their contents.

Certain embodiments of the invention provide systems and methods for tracking objects in transit. Some embodiments comprise measuring at least one environmental condition experienced by an object in transit. Some of these embodiments comprise detecting the presence of an adjacent network accessible by the object. Some embodiments comprise transmitting information associated with the object through the network in response to detecting an adjacent network. In some of these embodiments, the transmitted information includes an object identification and a history of measurements of the environmental condition.

In some of these embodiments, the step of detecting is performed after the object is moved from a first location to a second location. Some of these embodiments comprise determining that the object has been moved based on a loss of connection with the adjacent network. Some of these embodiments comprise identifying the physical location of the object, wherein the step of transmitting information includes transmitting an identification of the physical location. Some of these embodiments comprise identifying the physical location of the object is based on information maintained by a component in the adjacent network. In some of these embodiments, identifying the physical location of the object is performed by a tracking device attached to the object. In some of these embodiments, the step of transmitting information is performed by the tracking device. In some of these embodiments, the tracking device includes a wireless sensor configured to perform the detecting step.

In some of these embodiments, the object is a shipping package 100 comprising a temperature controlled chamber accessed through an opening and wherein the tracking device is attached to a plug that seals the opening. In some of these embodiments, an environmental condition is monitored where the environmental condition includes a measured temperature within the temperature controlled chamber. The measured temperature may be acquired by a sensor that protrudes from a bottom surface of the plug a predetermined distance into the chamber. In some of these embodiments, the at least one environmental condition includes a plurality of temperatures within the temperature controlled chamber, wherein at least some of the plurality of temperatures are calculated based on the measured temperature and a table of temperature gradients.

In some of these embodiments, the history of measurements comprises measurements obtained at a selected sample rate. Some of these embodiments comprise comparing the history of measurements with a set of expected measurements, wherein the history of measurements. Some of these embodiments comprise generating an alarm when the history measurements deviate from the expected measurements by more than a maximum tolerance value. In some of these embodiments, the sample rate is adjusted based on the time separation of corresponding expected measurements.

In some of these embodiments, the weight of the object is determined by a sensor mounted in an engineered cavity in the bottom of the container so as to provide a stable weight measurement when the box is not seated in an upright orientation. In some of these embodiments, the weight of the object is used to calculate remaining amount of refrigerant and the useful life of the cold storage remaining. In some of these embodiments, the weight of the Dewar 102 is determined from automated scan code information received from a shipping company, and the remaining life of the Dewar 102 is calculated accordingly.

Some of these embodiments comprise electronics and sensors attached or integrated into a monitoring device. In some of these embodiments, the at least some of the electronics and sensors are encapsulated into a plug that fits into the neck of a chamber (e.g. of a Dewar 102). In some of these embodiments, a temperature sensor protrudes a short distance from the bottom of the plug into a space cavity above the contents of the chamber. In some of these embodiments, temperature of the contents is determined with reference to a table of gradients.

In some of these embodiments, monitoring device may enter periods of over or under sampling in response to the need to record information with more resolution or fidelity. In some of these embodiments, a ship profile is loaded into the device at the time of shipment, and the progress of the shipment is monitored and alarms are generated in response to deviations from expected observations. In some of these embodiments, this information and analysis may be accomplished solely by the device, by the portal or in combination of the two working together.

Certain embodiments of the invention provide systems and methods in which a web portal controller automatically schedules a pickup for a next leg in the ship plan in response to a determination from scan code or other sensor data that a previous leg has been delivered, and where the time elapsed between the two can be varied by the customer or portal.

Certain embodiments of the invention provide systems and methods for tracking an object while the object is in transit. Some of these embodiments comprise providing a shippable object with an electronic tag or transceiver may originate a bi-directional network connection and two-way communications. In some of these embodiments, the electronic tag is configured to periodically measure at least one environmental condition experienced by the shippable object. In some of these embodiments, the electronic tag is configured to detect the presence of one or more networks accessible by the electronic tag. In some of these embodiments, the electronic tag is configured to transmit information associated with the shippable object through the at least one accessible network when at least one accessible network is detected. In some of these embodiments, the transmitted information includes an identification of the shippable object and a history of at least one measurement of the environmental condition. In some of these embodiments, accessible networks include WiFi, WiMax, LAN, PAN, cellular and satellite networks. In some of these embodiments, accessible networks include networks having no encryption and/or password protection. In some of these embodiments, accessible networks include networks for which encryption keys and/or passwords are available to the electronic tag.

In some of these embodiments, presence of one or more accessible networks is detected after the shippable object is moved from a first location to a second location. In some of these embodiments, the electronic tag is configured to determining that the shippable object has been moved based on a loss of connection with a previously accessible network. In some of these embodiments, detecting the presence of one or more networks includes detecting a network accessible to the electronic tag while the shippable object is in transit between two physically remote locations. In some of these embodiments, the electronic tag is further configured to identify a physical location of the shippable object associated with each measurement of the environmental condition. In some of these embodiments, transmitting the information includes transmitting physical locations associated with measurements. In some of these embodiments, the shippable object comprises a Dewar 102 having a temperature controlled chamber and wherein the electronic tag comprises a wireless sensor. In some of these embodiments, the at least one environmental condition includes a temperature of the temperature controlled chamber. In some of these embodiments, the history of measurements comprises measurements obtained at a selected sample rate.

Some of these embodiments further comprise comparing the history of measurements with a set of expected measurements. Some of these embodiments comprise generating an alarm when the history of measurements deviates from the set of expected measurements by more than a maximum tolerance value. In some of these embodiments, the sample rate is adjusted based on a preselected variable and the physical location is identified based on identity of the at least one accessible network.

Certain embodiments of the invention provide a shipping package 100. In certain embodiments, the shipping package 100 comprises an inner enclosure adapted to carry one or more commodities during shipment. The inner enclosure may include an inner chamber defined by inner walls and/or an inner surface of the shipping package. In certain embodiments, the shipping package 100 comprises one or more bladders 504a, 504b, 504c, 604a, 604b, 604c conformed to the inner surface of the inner chamber and instrumented with at least one transducer. In certain embodiments, the shipping package 100 comprises a processing device configured to receive measurements from the at least one transducer, and to communicate the measurements to a networked device upon detecting the presence of a network.

In some of these embodiments, the networked device processes the measurements using a cloud-resident application. In some of these embodiments, the networked device transmits a command to the processing device that causes the processing device to adjust a configuration parameter. In some of these embodiments, the configuration parameter configures one or more of a sensor sample interval, a preferred network communication route, an allowed or prohibited network communication route, and a remote control of annunciators provided on the shipping package 100.

In some of these embodiments, the processing device is configured to determine a location of the shipping package 100 based on network infrastructure detected by the processing device. In some of these embodiments, the network infrastructure comprises processing device s associated with one or more other shipping containers. In some of these embodiments, the processing device is configured to determine a location of the shipping package 100 based on absence or presence of a shipping scan-code associated with the shipping package 100. In some of these embodiments, the processing device is configured to determine a location of the shipping package 100 based on GPS derived coordinates. In some of these embodiments, the processing device is configured to determine a location of the shipping package 100 based on one or more factors including an outside temperature, a sound frequency, altitude, the absence or presence of a detectable network address, and time-in-transit.

In some of these embodiments, information transmitted by the processing device is fused with data received from a carrier. In some of these embodiments, the data received from the carrier includes one or more of custody transfer, time, state, and weight information.

In some of these embodiments, one or more bladders 504a, 504b, 504c, 604a, 604b, 604c conformed to the inner surface of the inner chamber has a shape adapted to conform to certain contours of the shipping package 100, thereby providing maximum protection of the Thermal Source and the one or more commodities. In some of these embodiments, the one or more bladders 504a, 504b, 504c, 604a, 604b, 604c are shaped to minimize movement of an inner chamber of the container. In some of these embodiments, the one or more bladders 504a, 504b, 504c, 604a, 604b, 604c may have a collective shape that accommodates protrusions from a Dewar 102, including handles and fill tubes. In some of these embodiments, the one or more bladders 504a, 504b, 504c, 604a, 604b, 604c has one or more pockets that hold commodities, accessories or documentation.

In some of these embodiments, devices may be attached to the one or more bladders 504a, 504b, 504c, 604a, 604b, 604c. The devices may include sensors configured to measures the pressure of at least one bladder 604a, 604b, 604c or bladder segment. One or more of the devices may include a processor. Some of these embodiments comprise a band or a plurality of bands 518, 614a, 614b, 614c configured to maintain the bladders 504a, 504b, 504c, 604a, 604b, 604c in a desired position. In some of these embodiments, a strain gauge may be provided on certain bands 518, 614a, 614b, or 614c, where a strain gauge may be configured to measure the stress load of the corresponding band 518, 614a, 614b, or 614c, the stress load being indicative of the weight of the Thermal Source. In some of these embodiments, the measurement of the stress load of the band 518, 614a, 614b, or 614c is used to determine the weight of the one or more commodities. In some of these embodiments, the one or more bladders 504a, 504b, 504c, 604a, 604b, 604c absorb shock and vibration. In some of these embodiments, a bladder 604a, 604b, 604c may be multi-segmented, each segment maintaining a uniform pressure such that vectors of arrival of the shock and vibration are perpendicular to the one or more commodities.

In some of these embodiments, differential pressure between at least a segment of the one or more bladders 504a, 504b, 504c, 604a, 604b, 604c and external atmospheric pressure is used to adjust pressure measurements responsive to changes in atmospheric pressure. In some of these embodiments, the differential pressure is used to calculate altitude of an aircraft, wherein the altitude is calculated based on acceleration. In some of these embodiments, pressure measurements are based on the evaluation of its tilt or orientation in reference to the center of the earth. In some of these embodiments, the bladders 504a, 504b, 504c, 604a, 604b, 604c comprise a material or mesh having elastic properties that limit volumetric expansion, thereby assuring accurate pressure measurement.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. An apparatus comprising:
a container having an inner chamber adapted to carry a thermal source and a commodity during shipment, wherein the inner chamber is defined by an inner surface of the container;
a bladder conformed to at least a portion of the inner surface of the container;
a band provided around the bladder;
a plurality of sensors including a strain gauge attached to the band and configured to measure stress load in the band, wherein the stress load in the band is indicative of combined weight of the thermal source and the commodity; and
a processing device coupled to the strain gauge and configured to:
determine an initial weight measurement of the thermal source based on a measurement of stress load provided by the strain gauge and prior measurements of weight of the thermal source and the commodity;
adjust the initial weight measurement to correct for tilt or inclination of the apparatus;
establish an opportunistic connection with a network at a plurality of locations along a shipping route; and
communicate measurements of weight or stress load to a networked device when the opportunistic connection is established at one of the plurality of locations along the shipping route.

2. The apparatus of claim 1, and further comprising:
an additional bladder conformed to a portion of the inner surface of the container; and
an additional band provided around the additional bladder,
wherein the plurality of sensors includes a strain gauge attached to the additional band and configured to measure stress load in the additional band,
wherein the processing device is coupled to the additional strain gauge and configured to adjust the initial weight measurement based on measurement of stress load provided by the additional strain gauge.

3. The apparatus of claim 2, wherein tilt or inclination of the apparatus is determined calculated from measurements of stress load in a plurality of bands provided around a plurality of bladders.

4. The apparatus of claim 1, wherein:
the bladder comprises a plurality of bladder segments;
the band is one of a plurality of bands, each band provided around a corresponding bladder segment;
the plurality of sensors includes a strain gauge attached each band in the plurality of bands, each strain gauge configured to measure stress load in a corresponding band; and
the processing device is configured to adjust the initial weight measurement based on measurements of stress load provided by a plurality of strain gauges.

5. The apparatus of claim 4, wherein tilt or inclination of the apparatus is determined calculated from measurements of stress load in the plurality of bands provided around the plurality of bladder segments.

6. The apparatus of claim 4, wherein the plurality of bladder segments is configured to maintain a uniform pressure such that vectors of arrival of shock and vibration are perpendicular to the commodity, and wherein the plurality of sensors include at least one transducer configured to measure a pressure of at least one bladder segment.

7. The apparatus of claim 1, wherein:
the networked device processes the measurements using a cloud-resident application;
the networked device transmits a command to the processing device that causes the processing device to adjust a configuration parameter; and
the configuration parameter configures one or more of a sensor sample interval, a preferred network communication route, an allowed network communication route, a prohibited network communication route, or a remote control of an annunciator provided on the apparatus.

8. The apparatus of claim 1, wherein the measurements are communicated to the networked device through an end-to-end network, utilizing a single protocol, in a single stateful session where the processing device self-determines the source and final destination address of the measurements.

9. The apparatus of claim 1, wherein the processing device is configured to:
determine a location of the apparatus based on presence or absence of network infrastructure detected by the processing device or absence of network infrastructure detectable by the processing device.

10. The apparatus of claim 1, wherein the processing device is configured to:
determine a location of the apparatus based on presence or absence of a processing device associated with one or more other apparatus.

11. The apparatus of claim 1, wherein the processing device is configured to:
determine a location of the apparatus based on coordinates derived from a GPS signal, wherein the apparatus is determined to be located within a structure when no GPS signal is detected.

12. The apparatus of claim 1, wherein the processing device is configured to:
determine a location of the apparatus based on one or more factors including an outside temperature, a sound frequency, altitude, absence of a network, presence of a network, a network address, or time-in-transit.

13. The apparatus of claim 1, wherein information transmitted by the processing device is fused with data received from a customer or carrier, wherein the data includes one or more of custody transfer, time, state information, weight information or networks detected along a shipping route.

14. The apparatus of claim 1, wherein the plurality of sensors includes a transducer configured to provide differential pressure between at least a segment of at least one bladder and external atmospheric pressure, wherein the differential pressure is indicative of the weight of the thermal source.

15. The apparatus of claim 1, wherein one or more of a change detected in radio frequency environment, absence of a network, presence of a network, a differential pressure, a vibration, an acceleration or a tilt is used to determine if the apparatus is on an aircraft or other vehicle.

16. The apparatus of claim 1, wherein the bladder comprises a material or mesh having elastic properties that limit volumetric expansion and assure accurate pressure measurement, and wherein at least one of the plurality of sensors is configured to measure stress load associated with the material or mesh.

17. The apparatus of claim 1, wherein the band is configured to maintain the bladder in a desired position.

18. The apparatus of claim 1, further comprising:
at least one transducer coupled to a plate located under the thermal source.

19. The apparatus of claim 18, wherein the at least one transducer comprises a microelectromechanical system (MEMS) device.

20. The apparatus of claim 1, wherein the bladder is configured to absorb shock and vibration affecting the apparatus during shipment.
